(19) United States
(12) Patent Application Publication
(10) Pub. No.: US 2006/0112678 A1
(43) Pub. Date: Jun. 1, 2006

(54) Multiple reactant multiple catalyst selective catalytic reduction for NOx abatement in internal combustion engines

(75) Inventors: Wayne Scott Kaboord, Oregon, WI (US); Daniel Woodrow Fellers, Milwaukee, WI (US)

Correspondence Address: PAUL V. KELLER, LLC, 4585 LIBERTY RD., SOUTH EUCLID, OH, 44121, US

(73) Assignee: Eaton Corporation, Cleveland, OH (US)

(21) Appl. No.: 10/981,035

(22) Filed: Nov. 4, 2004

(51) Int. Cl. B01D 53/56

(52) U.S. Cl. 60/274; 423/239.1

(57) ABSTRACT

The invention relates to systems and methods for treating oxygen-rich NOₓ-containing exhaust. The systems and methods comprise using first and second NOₓ reducing catalysts. According to one aspect of the invention, the first catalyst reduces NOₓ in oxygen-rich exhaust primarily through reaction with a first reductant species and the second catalyst reduces NOₓ in oxygen-rich exhaust primarily through reaction with a second reductant species. Collectively, the two catalysts are substantially more effective than either of the catalysts individually in reducing the concentration of NOₓ in the exhaust. According to another aspect of the invention, an exhaust system is configured to inject a first reductant species primarily at a first location upstream of the first NOₓ reducing catalyst, and is configured to inject a second reductant species primarily at a second location downstream of the first NOₓ reducing catalyst, but upstream of the second NOₓ reducing catalyst.

### FIELD OF THE INVENTION

The present invention relates to the field of pollution control devices for internal combustion engines.

### BACKGROUND OF THE INVENTION

NOₓ emissions from vehicles with internal combustion engines are an environmental problem recognized worldwide. Several countries, including the United States, have long had regulations pending that will limit NOₓ emissions. Manufacturers and researchers have put considerable effort toward meeting those regulations.

In conventional gasoline powered vehicles that use stoichiometric fuel-air mixtures, three-way catalysts have been shown to control NOₓ emissions. In diesel-powered vehicles and vehicles with lean-burn gasoline engines, however, the exhaust is too oxygen-rich for three-way catalysts to be effective.

Several solutions have been proposed for controlling NOx emissions from diesel-powered vehicles and lean-burn gasoline engines. One set of approaches focuses on the engine. Techniques such as exhaust gas recirculation and homogenizing fuel-air mixtures can reduce NOx production. These techniques alone, however, will not eliminate NOx emissions. Another set of approaches remove NOx from the vehicle exhaust. These include the use of NOₓ adsorber-catalysts, selective catalytic reduction (SCR), and lean-burn NOₓ catalysts.

NOx adsorber-catalysts alternately adsorb NOx and catalytically reduce it. The adsorber can be taken offline during regeneration and a reducing atmosphere provided. The adsorbant is generally an alkaline earth oxide adsorbant, such as BaCO₃ and the catalyst can be a precious metal, such as Ru.

SCR involves using ammonia as the reductant. The NOx can be temporarily stored in an adsorbant or ammonia can be fed continuously into the exhaust. SCR can achieve NOx reductions in excess of 90%, however, there is concern over the lack of infrastructure for distributing ammonia or a suitable precursor. SCR also raises concerns relating to the possible release of ammonia into the environment.

Lean-burn NOx catalysts promote the reduction of NOₓ under oxygen-rich conditions. Reduction of NOx in an oxidizing atmosphere is difficult. It has proved challenging to find a lean-burn NOₓ catalyst that has the required activity, durability, and operating temperature range. Taking into account losses of activity that occur after short periods of use, limits on catalyst amount placed by cost, and limits on catalyst bed size placed by engine back-pressure intolerance, no catalyst has been found that provides satisfactory conversion. Of further concern with respect to lean-burn NOx catalysts is that a reductant, such as diesel fuel, must generally be injected into the exhaust leading to a significant fuel economy penalty. For the foregoing reasons, after considerable research, the industry has shifted resources away from research on lean-burn NOx catalyst in favor of research and development of other approaches to NOx mitigation.

U.S. Pat. No. 5,233,830 describes an exhaust treatment system having a lean-NOₓ catalyst located upstream of a three-way catalyst. Under lean operating conditions, the lean-NOₓ catalyst removes NOₓ and the three-way catalyst removes CO and hydrocarbons.

U.S. Pat. No. 6,670,296 describes a lean NOₓ catalyst structure comprising a combination of an alkaline earth-zeolite catalyst with an alkaline earth-alumina catalyst. As the catalyst temperature varies, the relative contributions of the two components to the overall reduction of NOₓ changes.

There remains a long-felt need for an effective exhaust treatment system based on reduction of NOₓ in a lean atmosphere.

### SUMMARY OF THE INVENTION

The following presents a simplified summary in order to provide a basic understanding of some aspects of the invention. This summary is not an extensive overview of the invention. The primary purpose of this summary is to present some concepts of the invention in a simplified form as a prelude to the more detailed description that is presented later.

The invention relates to systems and methods for treating oxygen-rich NOₓ-containing exhaust. The systems and methods comprise using first and second NOₓ reducing catalysts. According to one aspect of the invention, the first catalyst reduces NOₓ in oxygen-rich exhaust primarily through reaction with a first reductant species and the second catalyst reduces NOₓ in oxygen-rich exhaust primarily through reaction with a second reductant species. Collectively, the two catalysts are substantially more effective than either of the catalysts individually in reducing the concentration of NOₓ in the exhaust. The invention can reduce the fuel penalty associated with exhaust treatment by lean-NOₓ catalysts and can provide greater conversion than would be achieved using an equal amount of a single catalyst.

According to another aspect of the invention, an exhaust system is configured to inject a first reductant species primarily at a first location in the exhaust system, the first location being upstream of the first NOₓ reducing catalyst, and is configured to inject a second reductant species primarily at a second location in the exhaust system, the second location being downstream of the first NOₓ reducing catalyst, but upstream of the second NOₓ reducing catalyst. The reductants can be obtained by reforming fuel and separating the reductants prior to injection. This aspect of the invention can also improve reductant utilization and overall conversion.

To the accomplishment of the foregoing and related ends, the following description and annexed drawings set forth in detail certain illustrative aspects and implementations of the invention. These are indicative of but a few of the various ways in which the principles of the invention may be employed. Other aspects, advantages and novel features of the invention will become apparent from the following detailed description of the invention when considered in conjunction with the drawings.

### BRIEF DESCRIPTION OF THE DRAWINGS

FIG. 1 is a schematic illustration of an exhaust treatment system according to one embodiment of the invention.

FIG. 2 is a schematic illustration of an exhaust treatment system according to another embodiment of the invention.

FIG. 3 is a schematic illustration of an exhaust treatment system according to a further embodiment of the invention.

### DETAILED DESCRIPTION OF THE INVENTION

The invention provides exhaust treatment systems for removing NOx from oxygen-rich exhaust. NOₓ includes, without limitation, NO, NO₂, and N₂O₂. The invention functions by reducing NOₓ to N₂ and/or N₂O in an oxygen-rich environment using at least two separate lean-NOx catalysts. One catalyst is adapted to reduce NOx by catalyzing a reaction with a first reductant species while the other is adapted to reduce NOx by catalyzing a reaction with a second, distinct reductant species.

The invention is based on the observation that lean-burn NOₓ catalysts are each generally adapted to catalyze reduction with only one reductant species. The inventors have concluded that it is more efficient to use multiple lean-burn NOx catalyst rather than an equal (in some sense) amount of one lean-burn NOx catalyst. One potential advantage is that available reductants unutilized by single-catalyst systems can be taken advantage of, reducing the fuel penalty associated with exhaust treatment by lean-burn NOx catalysts. Another potential advantage is that greater reduction in NOx concentration can be achieved at fixed cost or fixed engine back-pressure. Ultimately, by combining multiple lean-burn NOx catalysts, emission control standards can be met that could not be met practically using only one lean-burn NOx catalyst.

Optionally, the exhaust treatment system can include a third lean-NOx catalyst adapted to catalyze reduction with a third reductant species. An exhaust treatment system according to the invention can be provided as part of a power generation system, which may power a vehicle. The invention is specifically adapted for use in power generation systems comprising diesel or lean-burn gasoline engines.

In operation, each of the lean-burn NOx catalysts contributes significantly to the overall NOx conversion. Generally NOx conversion across each of the catalysts is at least about 20%. Preferably, NOx conversion across each of the first and second lean-NOx catalysts is at least about 40%, more preferably at least about 60%.

A reducing agent species is any substance, or group of substances, that can act as oxygen acceptors in a NOₓ reduction reaction. Examples of NOₓ reducing species include H₂, CO, hydrocarbons, and oxygenated hydrocarbons. In the context of the present invention, hydrocarbons as a group can be considered one reducing species.

The catalysts used by the invention are effective in oxygen-rich environments and the reduction of NOx that occurs in methods of the invention occurs in an oxygen-rich environment. An oxygen rich environment generally comprises at least about 3% oxygen and more typically comprises at least about 5% oxygen.

Lean-NOx catalysts generally have limited operating temperature windows and are generally specific to one or a small number of reductant species. A lean-NOx catalyst that is active with respect to more than one reductant species is likely to be active for those species in different temperature ranges. In the context of the present invention, when discussing first and second catalysts, it is to be understood that the catalysts are generally chemically different and if they are not, they are physically separated into different beds and are configured to operate simultaneously, but at significantly different temperatures.

Examples of lean-NOx catalysts adapted to use CO as a reductant include Rh on various supports. One example is Rh on a CeO₂—ZrO₂ support, which can be effective in a temperature range from about 250 to about 350° C. Another example is Cu and/or Fe supported on ZrO₂, which can be effective at 150° C. with selectivity to N₂ improving up to about 250° C.

Examples of lean-NOx catalysts adapted to use H₂ as a reductant include Pt on various supports, such as Pt on alumina, silica, zeolites, and mixed metal oxides. Pt over an appropriate zeolite can be effective in a temperature range from about 100 to about 150° C. Pt supported on a mixed LaMnO₃, CeO₂, and MnO₂ can be effective in a temperature range from about 100 to about 200° C.

Examples of lean-NOx catalysts adapted to use HC as a reductant include transitional metal exchanged zeolites, such as Cu/ZSM-5 and Fe/ZSM-5, and other bulk impregnated or ion exchanged zeolites. Suitable substances for bulk impregnation or ion exchange include, without limitation, Pt, Co, and Ce. Cu/ZSM-5 catalyzes reduction of NOₓ with hydrocarbons in the temperature range from about 300 to about 450° C. Pt supported on carbon can be effective in a temperature range from about 225 to about 275° C.

Examples of lean-NOx catalysts adapted to use oxygenated hydrocarbons as a reductant include Ag supported on alumina, Ba/Y-zeolite (when NO is first oxidized to NO₂).

More generally speaking, lean-burn NOx catalysts include, without limitation, transitional metals on supports including, without limitation, zeolites, pillared clays, metal oxides, such as alumina and silica, and activated carbon. A support that affects the catalytic properties is distinguished from an inert support that provides an appropriate structure to the catalyst. For example, the catalyst may be coated over a cordierite or metal monolith support.

Optionally, an exhaust system of the invention further includes a catalyst adapted to catalyze reduction of N₂O to N₂. Suitable catalysts for reducing N₂O may include Rh of ZSM-5 or alumina at temperatures in excess of about 275° C. Cu and Co exchanged zeolites can also be effective for this purpose at temperatures of at least about 350° C.

Where catalysts have a sufficiently overlapping temperature window, they may be physically intermixed or loaded sequentially on a single support. A rigid monolith support may be coated with two separate catalysts by dipping one end in a solution depositing the first catalyst and the other end in a solution depositing a second catalyst. Alternatively, separate catalysts can be coated on separate metal sheets or wire screens, which can then be rolled and the rolls packed sequentially in a canister to form monolith or monolith-like structures.

The reductant source can be exclusively the engine, however, it is more typical that one or more reductants are injected into the exhaust stream. A preferred reductant is the fuel used to power the engine, such as diesel fuel, or a product derived from that fuel. The fuel can be used directly as a reductant or reformed to produce a plurality of reductants. A reformer for this purpose can be provided as part of the exhaust treatment system. The fuel can be reformed prior to injection or after injection into the exhaust stream.

Any type of fuel reformer can be used. Reformers vary in terms of the amount and types of oxygen sources supplied and the steps taken to promote reaction. An oxygen source is generally either oxygen or water. Oxygen can be supplied from air, from lean exhaust, or in a relatively pure form, as in oxygen produced from hydrogen peroxide or water. Partial oxidation by oxygen is exothermic and partial oxidation by water in endothermic. A balance between the two can be selected to achieve a desired degree of heat release, heat consumption, or an energy neutral reaction. A reformer can promote reaction with one or more of heat, a catalyst, and plasma. Plasma is typically generated with an electric arc. Specific reformer types include steam reformers, autothermal reformers, partial oxidation reformers, and plasma reformers.

Reformer products generally include at least H₂ and CO, but can also include light hydrocarbons and oxygenated hydrocarbons. These products can be injected together, however, in one embodiment the first and second reductants are introduced into the exhaust at separate locations, for example, upstream of the first catalyst and downstream between the first and second catalysts. An advantage of such a configuration is that the second reductant is not consumed by undesired reactions over the first catalyst.

Where separate injection of two reductants obtained from reformed fuel is desired, a separation process can be employed. Suitable separation processes include membrane and adsorption-based separation processes.

Where the catalysts are not intermixed, they can be ordered in any suitable fashion. One basis for ordering is to place the catalysts in order of decreasing operating temperature range, whereby the natural tendency of the exhaust to cool can be used to bring the exhaust to an appropriate temperature through each of the catalysts. Another consideration is to use the less reactive catalyst/reductant combinations up front where the NOx concentration is highest. The higher NOx concentration increases the reaction rate, and pairing the higher NOx concentration with the less reactive catalyst/reductant tends to balance the utilization of the various reductants and improve overall conversion. A third consideration is to place a catalyst that is effective at reducing N₂O to N₂ near the back of the system to reduce N₂O produced by an otherwise effective catalyst that has a poor selectivity between N₂O and N₂. A fourth consideration is that some lean-NOx catalysts show some sensitivity to oxygen and are more effective at lower oxygen concentrations. It may be desirable to place these catalysts further downstream where the oxygen concentration has been lowered by action of the upstream catalysts.

For some of the forgoing orderings, it may be necessary to heat the exhaust. The exhaust may be heated by heat exchange with any suitable source, including for example a hotter part of the exhaust system, the engine, or a fuel reformer. The exhaust may also be heated by other means, such as combusting a small amount of fuel in the exhaust or even electrically heating.

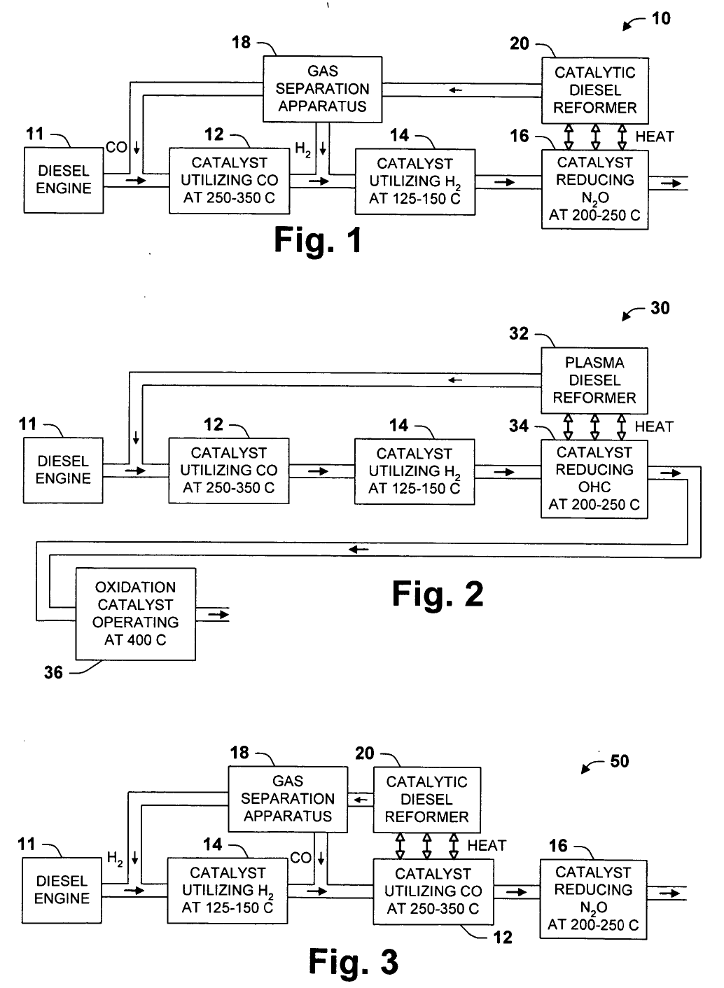

FIG. 1 is a schematic illustration of an exhaust treatment system 10 according to one embodiment of the present invention. Exhaust produced by a diesel engine 11 first passes through a catalyst 12 utilizing CO as a reductant at a temperature between 250 and 350° C., then through a catalyst 14 using H₂ as a reductant at a temperature between 125 and 150° C., then through a N₂O reducing catalyst 16 operating at a temperature between about 200 and 250° C. Reductants including CO and H₂ are supplied from a catalytic diesel reformer 20. Heat from the reformer 20 is used to heat the N₂O reducing catalyst 16. The reductants are separated by a gas separation apparatus 18. CO from the gas separation apparatus 18 is injected into the exhaust stream upstream of the catalyst 12 and H₂ from the gas separation apparatus 18 is injected downstream of the catalyst 12, but upstream of the catalyst 14. This configuration uses hydrogen to treat the more dilute partially treated exhaust.

FIG. 2 is a schematic illustration of an exhaust treatment system 30 according to another embodiment of the present invention. Exhaust produced by the diesel engine 11 first passes through the catalyst 12 utilizing CO as a reductant at a temperature between 250 and 350° C., then through a catalyst 14 using H₂ as a reductant at a temperature between 125 and 150° C., then through a catalyst 34 using oxygenated hydrocarbons as the reductant at a temperature between 200 and 250° C., and then through an oxidation catalyst 36. The oxidation catalyst 36 oxidizes unused reductants. Reductants are supplied by a plasma diesel reformer 32 and introduced into the exhaust stream upstream of the first catalyst. Energy from the plasma diesel reformer 32 is used to heat the catalyst 34. This configuration utilizes all three reductants produced by the plasma diesel reformer 32.

FIG. 3 is a schematic illustration of an exhaust treatment system 50 according to further embodiment of the present invention. Exhaust produced by a diesel engine 11 first passes through the catalyst 14 using H₂ as a reductant at a temperature between 125 and 150° C., then through the catalyst 12 utilizing CO as a reductant at a temperature between 250 and 350° C., then through a N₂O reducing catalyst 16 operating at a temperature between about 200 and 250° C. Reductants including CO and H₂ are supplied from a catalytic diesel reformer 20. Heat from the reformer 20 is used to heat the catalyst 12. The reductants are separated by a gas separation apparatus 18. H₂ from the gas separation apparatus 18 is injected into the exhaust stream upstream of the catalyst 14 and CO from the gas separation apparatus 18 is injected downstream of the catalyst 14, but upstream of the catalyst 12. This configuration places the CO-utilizing catalyst 12 in a lower oxygen concentration environment than the configuration of FIG. 1.

The invention has been shown and described with respect to certain aspects, examples, and embodiments. While a particular feature of the invention may have been disclosed with respect to only one of several aspects, examples, or embodiments, the feature may be combined with one or more other features of the other aspects, examples, or embodiments as may be advantageous for any given or particular application.

The claims are:

1. An exhaust system adapted to process oxygen-rich NOₓ-containing exhaust from an internal combustion engine, comprising:
first and second NOₓ reducing catalysts;
wherein the first and second catalysts collectively are operative to reduce NOₓ to N₂ in oxygen-rich exhaust and are substantially more effective than either of the catalysts individually in reducing the concentration of NOₓ in the exhaust;
the first catalyst reduces NOₓ primarily through reaction with a first reductant species; and
the second catalyst reduces NOₓ primarily through reaction with a second reductant species.

2. A power generation system for a vehicle comprising the exhaust system of claim 1.

3. The power generation of claim 2, wherein the power generation system comprises a diesel engine.

4. A vehicle comprising the power generation system of claim 2.

5. The exhaust system of claim 1, wherein the exhaust system is configured to sequentially pass the exhaust over the first and then the second catalyst.

6. The exhaust system of claim 5, wherein the first reductant species is carbon monoxide.

7. The exhaust system of claim 5, wherein the exhaust system is configured for the second catalyst to operate at a higher temperature than the first catalyst.

8. The exhaust system of claim 1, wherein the first catalyst is operative to reduce at least about 40% of the NOₓ in the exhaust and the second catalyst is operative to reduce at least about 40% of the remaining NOₓ in the exhaust.

9. The exhaust system of claim 8, wherein the first catalyst is operative to reduce at least about 60% of the NOₓ in the exhaust and the second catalyst is operative to reduce at least about 60% of the remaining NOₓ in the exhaust.

10. The exhaust system of claim 1, wherein the first and second reductant species are selected from the group consisting of hydrogen, carbon monoxide, hydrocarbons, oxygenated hydrocarbons, and mixtures thereof.

11. The exhaust system of claim 1, further comprising:
a third NOₓ reducing catalyst;
wherein the third catalyst reduces NOₓ primarily through reaction with a third reductant species.

12. The exhaust system of claim 11, wherein the first reductant species is hydrogen, the second reductant species is carbon monoxide, and the third reductant species is selected from the group consisting of hydrocarbons and oxygenated hydrocarbons.

13. The exhaust system of claim 1, further comprising a reductant injection system operative to introduce at least one of the first and the second reductant species into the exhaust.

14. The exhaust system of claim 13, wherein the reductant injection system is operative to introduce both the first and the second reductant species into the exhaust.

15. The exhaust system of claim 14, wherein the reductant injection system is configured to inject the first reductant species primarily at a first location in the exhaust system and to inject the second reductant species primarily at a second location in the exhaust system.

16. The exhaust system of claim 13, wherein the reductant injection system comprises a fuel reformer.

17. The exhaust system of claim 1, further comprising an N₂O reducing catalyst operative to substantially reduce an N₂O content of the exhaust.

18. A method of reducing NOₓ in oxygen-rich internal combustion engine exhaust, comprising:
treating the exhaust with first and second NOₓ reducing catalysts;
wherein the first and second catalysts are collectively more effective than either of the catalysts individually in reducing the NOx concentration of the exhaust;
the first catalyst reduces NOₓ primarily through reaction with a first reductant species; and
the second catalyst reduces NOₓ primarily through reaction with a second reductant species.

19. A method of operating a power generation system comprising reducing NOₓ in oxygen-rich internal combustion engine exhaust according to the method of claim 18.

20. A method of operating a power generation system comprising reducing NOₓ in oxygen-rich diesel engine exhaust according to the method of claim 18.

21. A method of operating a vehicle comprising powering the vehicle with a power generation system operated according to the method of claim 19.

22. The method of claim 18, wherein the exhaust is passed sequentially over the first and then the second catalyst.

23. The method of claim 22, wherein the first reductant species is carbon monoxide.

24. The method of claim 22, wherein the second catalyst is operated at a higher temperature than the first catalyst.

25. The method of claim 22, wherein the first catalyst reduces at least about 40% of the NOₓ in the exhaust and the second catalyst reduces at least about 40% of the remaining NOₓ in the exhaust.

26. The method of claim 25, wherein the first catalyst reduces at least about 60% of the NOₓ in the exhaust and the second catalyst reduces at least about 60% of the remaining NOₓ in the exhaust.

27. The method of claim 18, wherein the first and second reductant species are selected from the group consisting of hydrogen, carbon monoxide, hydrocarbons, oxygenated hydrocarbons, and mixtures thereof.

28. The method of claim 18, further comprising:
treating the exhaust with a third NOₓ reducing catalyst;
wherein the third catalyst reduces NOₓ primarily through reaction with a third reductant species.

29. The method of claim 28, wherein the first reductant species is hydrogen, the second reductant species is carbon monoxide, and the third reductant species is selected from the group consisting of hydrocarbons and oxygenated hydrocarbons.

30. The method of claim 18, further comprising introducing at least one of the first and the second reductant species into the exhaust after the exhaust leaves the engine.

31. The method of claim 30, wherein both the first and the second reductant species are introduced into the exhaust after the exhaust leaves the engine.

32. The method of claim 31, wherein the first reductant species is introduced into the exhaust primarily at a first location and the second reductant species is introduced into the exhaust primarily at a second location.

33. The method of claim 32, wherein the first and second reductants are obtained from reformed fuel.

34. The method of claim 18, further comprising passing the exhaust over a third catalyst that reduces N₂O in the exhaust and substantially reduces an N₂O content of the exhaust.

35. An exhaust system adapted to process oxygen-rich NOₓ-containing exhaust from an internal combustion engine, comprising:
first and second NOₓ reducing catalysts;
wherein the exhaust system is configured to inject a first reductant species primarily at a first location in the exhaust system, the first location being upstream of the first NOₓ reducing catalyst, and a second reductant species primarily at a second location in the exhaust system, the second location being downstream of the first NOₓ reducing catalyst, but upstream of the second NOₓ reducing catalyst;
the first catalyst operates to reduce NOₓ through reaction with the first reductant species; and
the second catalyst operates to reduce NOₓ through reaction with the second reductant species.

36. A power generation system for a vehicle comprising the exhaust system of claim 35.

37. The power generation of claim 36, wherein the power generation system comprises a diesel engine.

38. A vehicle comprising the power generation system of claim 36.

39. The exhaust system of claim 35, further comprising
a fuel reformer; and
a gas separation apparatus;
wherein the fuel reformer is operative to produce the first and the second reductant species; and
the gas separation apparatus is configured to substantially separate the first and second reductant species.

40. The exhaust system of claim 39, wherein the gas separation apparatus comprises a selectively permeable membrane.

41. The exhaust system of claim 39, wherein the first and second reductant species are selected from the group consisting of H₂ and CO.

42. A method of reducing NOₓ in oxygen-rich internal combustion engine exhaust, comprising:
introducing a first reductant into the exhaust;
passing the exhaust over a first NOx reducing catalyst;
introducing a second reductant into the exhaust; and
passing the exhaust over a second NOx reducing catalyst;
wherein the first and second reductants are different species.

43. A method of operating a power generation system comprising reducing NOₓ in oxygen-rich internal combustion engine exhaust according to the method of claim 42.

44. A method of operating a power generation system comprising reducing NOₓ in oxygen-rich diesel engine exhaust according to the method of claim 43.

45. A method of operating a vehicle comprising powering the vehicle with a power generation operated according to the method of claim 43.

46. The method of claim 42, wherein the second catalyst is operated at a higher temperature than the first catalyst.

47. The method of claim 42, wherein the first catalyst reduces at least about 40% of the NOₓ in the exhaust and the second catalyst reduces at least about 40% of the remaining NOₓ in the exhaust.

48. The method of claim 47, wherein the first catalyst reduces at least about 60% of the NOₓ in the exhaust and the second catalyst reduces at least about 60% of the remaining NOₓ in the exhaust.

49. The method of claim 42, wherein the first and second reductant species are selected from the group consisting of hydrogen, carbon monoxide, hydrocarbons, oxygenated hydrocarbons, and mixtures thereof.

50. The method of claim 42, further comprising:
treating the exhaust with a third NOₓ reducing catalyst;
wherein the third catalyst reduces NOₓ primarily through reaction with a third reductant species.

51. The method of claim 42, further comprising passing the exhaust over a third catalyst that reduces N₂O in the exhaust and substantially reduces an N₂O content of the exhaust.
